(19) United States
(12) Patent Application Publication
(10) Pub. No.: US 2008/0020199 A1
(43) Pub. Date: Jan. 24, 2008

(54) Sound Insulator For The Passenger Compartment Of A Motor Vehicle

(75) Inventors: Hans-Peter Augele, Heidelberg (DE); Achim Bauer, Herrenberg (DE); Ingo Busch, Boeblingen (DE); Klaus-Peter Claar, Horb (DE); Bernd Harloff, Boeblingen (DE); Guenter Koelle, Sindelfingen (DE); Torsten Koenig, Esslingen (DE); Michael Neis, Simmozheim (DE); Karl Scheible, Ehningen (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 11/659,382

(22) PCT Filed: Jul. 22, 2005
(86) PCT No.: PCT/EP05/08024

§ 371 Date: Jun. 21, 2007

(30) Foreign Application Priority Data
Aug. 4, 2004 (DE) 10 2004 037 767.7

(51) Int. Cl. G10K 11/168; B60R 13/08

(52) U.S. Cl. 428/312.6; 428/304.4

(57) ABSTRACT

A sound insulator for a motor vehicle passenger compartment is disclosed. The aim of the invention is to develop a sound insulator which makes it possible to obtain an improved damping effect within a frequency range less than 300 Hz. In that respect, the invention relates to a sound insulator for a motor vehicle passenger compartment, which comprises an air cushion consisting of a dampingly active envelope which is made of an elastic material and disposed between a sound-generating component and the compartment internal space. The invention provides for a sound damping layer (25) which matches the shape of said component (13), acts as a spring material system and is covered on the compartment side by a heavyweight film (26), thereby forming the first shell of the air cushion (29). The invention also provides for the second shell of the air cushion (29) which is tightly connected to the heavyweight film (26), consists of an elastic, preferably pre-shaped, film (27) which forms the cushion air between the first and second shell.

The present invention relates to a sound insulator for a passenger compartment of a vehicle, as known from the German Patent Application DE 101 05 891 A1.

Vehicles having a high level of comfort are characterized by a low noise level in the passenger compartment. Primary sources of noise include engine noises, rolling noises from the chassis and suspension, and wind noises from the body and built-on accessories. To maintain the lowest possible noise levels for the driver and passengers, various active and passive sound-insulation and sound-absorption measures are known. The noises originate from structural components that are subject to vibratory and shock-type loads, and propagate, in particular, in the form of structure-borne and airborne sound. Measures for insulating against structure-borne noise are directed to substantially preventing sound from propagating to the passenger compartment. In spite of measures for insulating against structure-borne noise, sound cannot be entirely prevented from propagating from the sound source to the passenger compartment. Structure-borne noise originating from structural components of the passenger compartment is transmitted as airborne noise to the ears of the vehicle occupant(s). By employing additional sound-damping measures, it is possible to reduce the noise level perceived by the vehicle occupants. In the context of sound damping, friction at the contact surfaces or internal friction in the damping materials causes disturbing structure-borne sound energy to be converted into heat. The components of a passenger compartment can be fabricated from special sound-absorbing materials, such as manganese alloys, or from combinations of standard body materials and plastic sound insulators. Antidrumming lining material on the sound-emitting components or sound-absorption elements of nonwoven materials or molded foam are suited for practical use.

In addition to their sound-damping properties, sound insulators should be low in weight, require little space, and be simple-to install. In this respect, the German Patent Application DE 101 05 891 A1 describes a sound-absorption element in the form of an inflatable air cushion which is placed at the surfaces of two spaced-apart components, one of the components being a sound-emitting component. This sound-absorption element is not able to completely cover the 100 to 8000 Hz range that is relevant to the human subjective aural impression. Vehicles having four-cylinder diesel engines and tires rolling on pavement produce noises in the frequency range below 200 Hz. In this range, the sound damping is less than satisfactory.

The German Patent Application DE 196 27 106 A1 discusses a sound-insulating insertion part that is provided in the floor area of a motor-vehicle passenger compartment. The insertion part is impact-resistant, shock-resistant and mechanically stable under load, and has air cells separated by supporting walls between a cover layer and an underside. In response to acoustic excitation from the underside, the air volumes contained in the cells function in the manner of damping springs of a spring-mass system. Air is exchanged among the cells via connecting channels. It may be that the brace-type supporting walls are necessary for impact resistance, but they form sound bridges which degrade the damping effect.

In the case of a sound-damping water-shield film in the interior of motor vehicle doors, as described by the German Patent Application DE 41 24 023 A1, two films of hard, dimensionally stable plastic are used, one of the films being embossed in such a way that air cells form, providing a sound-damping effect. The sound damping is not adequate for low frequencies.

The German Patent Application DE 100 22 902 A1 describes film-type absorbers for passenger compartments. The absorbers contain microholes and are placed in layers, in combination with nonwoven or foam absorbers or an air gap, on sound-emitting components. Here, the intention is to cover the entire frequency range audible to the human ear by coupling two absorbers. The film-type absorbers have a decorative effect. The microholes form open-pore surfaces, which are not always desirable because they are difficult to care for. A sound-damping element that is optimized for the entire frequency range does not yield maximum damping values at low frequencies.

It is, therefore, an object of the present invention to devise a sound insulator for a passenger compartment of a motor vehicle which will provide an improved damping action within the frequency range below 300 Hz.

This objective is achieved by a sound insulator having the features set forth in claim 1. Advantageous embodiments are delineated in the dependent claims.

In accordance with the present invention, a spring-mass system made of a foam or nonwoven material and of a heavyweight film is provided on a sound-emitting component of a passenger compartment and acts in conjunction with an adjacent air cushion. The air cushion is advantageously formed from the heavyweight film and from another elastic film. The elastic film and the heavyweight film are hermetically sealed together to permit formation of the air cushion therebetween. The foam layer or nonwoven layer may be adapted to the shape of the sound-emitting component, so that no or only few air voids are formed. The heavyweight film may be structurally joined to the layer of foam or nonwoven material by adhesive bonding or heat sealing, for example. The elastic film distal to the sound-emitting component may be formed or preshaped in such a way that, once an air cushion is deployed, it rests against surrounding components, conforming closely thereto.

A conventional mass-spring system typically provides a damping action within the range of 12-18 dB/octave. On the other hand, an enhanced damping action within the range of an additional 2 to 5 dB/octave is provided by combining the mass-spring system with the air cushion. In this context, the heavyweight film has at least the same, preferably, however, a substantially higher mass per unit area than the elastic film. Doubling the weight of the heavyweight film yields a 6 dB/octave improvement in the damping action. A system-related drop in the resonance damping of the sound insulator is tuned to an uncritical range by properly dimensioning the thickness of the foam layer or nonwoven layer and the mass per unit area of the heavyweight film.

Openings to the engine compartment are provided for components, such as a steering-column shaft, foot pedals or electrical lines, particularly in the front-end section of a passenger compartment of a motor vehicle having a front-mounted engine. The elastic film proximal to the interior of the passenger compartment is configured in such a way that, when the air cushion is deployed, these components are surrounded without any or with only small spaces being formed that allow sound transmission.

Because the sound velocity depends greatly on the temperature and the humidity of the air contained in the air cushion, the damping properties may be influenced by controlling the temperature and/or the air humidity in the same. It is possible to measure the sound-level values in the interior of the passenger compartment and, on the basis of these measured values, to set the temperature and/or humidity to a minimum sound level.

Besides having utility for vehicles, the present invention may also be usefully applied to stationary machines, installations or facilities, and other spaces where protecting people from undesirable noise emissions is paramount.

The present invention is explained in greater detail below with reference to an exemplary embodiment. In the drawing,

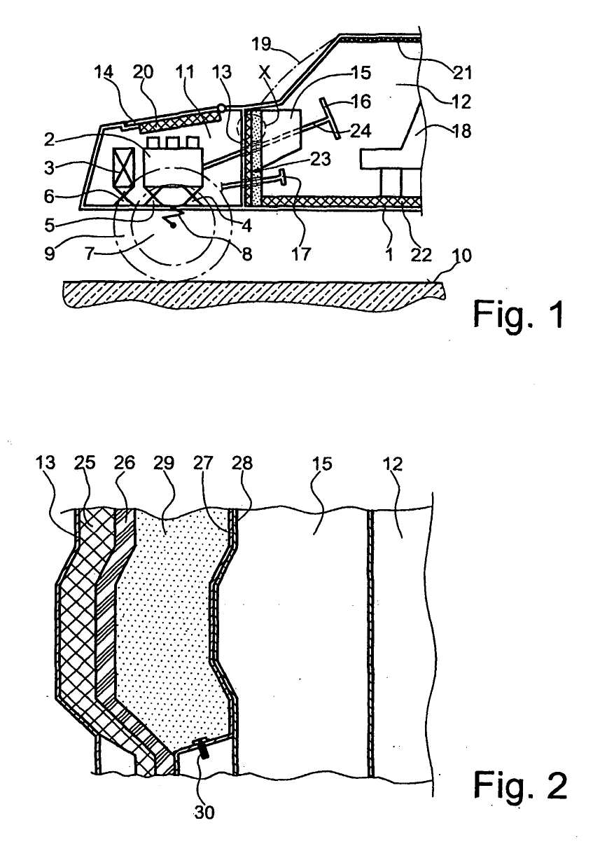

FIG. 1 shows a schematic representation of a passenger vehicle body having sound-insulation elements and sound-absorption elements; and

FIG. 2 shows a schematic representation of a layered configuration of a sound insulator according to the present invention.

FIG. 1 schematically illustrates a body 1 of a passenger vehicle in longitudinal section. Body 1 is made of welded sections of a steel material in which structure-borne noise is able to propagate virtually unhindered. Body 1 supports, inter alia (as examples of typically present aggregates), a four-cylinder diesel engine 2 and an electrically powered fan 3 for cooling engine 2 on demand. During operation of engine 2 and of fan 3, mechanical excitation within the frequency range audible to the human ear is generated by reciprocating and rotating components. To prevent propagation of the sound emanating from engine 2 and from fan 3, engine 2 and fan 3 are coupled via elastic sound-insulating elements 4-6 to body 1. Springs 8 are used to suspend the wheels (7) (shown as dashed lines) on the body 1 of the passenger vehicle, thereby reducing the transmission of rolling noises produced by tires 9 on roadway 10 to body 1. Body 1 includes, inter alia, an engine compartment 11 and a passenger compartment 12, which are separated by a front wall 13. Engine compartment 11 is closed from above by a hinged engine-compartment hood 14. The interior of passenger compartment 12 contains numerous built-in components, such as an instrument panel 15, a steering wheel 16, foot pedals 17, seats 18 and a window 19. To prevent noise from propagating from engine compartment 11 into the ambient surroundings, a sound-absorption mat 20 is provided on the underside of engine-compartment hood 14. To maintain the lowest possible noise level in passenger compartment 12, a sound-damping lining 21 is provided on the ceiling and a sound-damping carpet 22 on the floor panel. A sound insulator 23 bonded to front wall 13 on the side of passenger compartment 12 damps the sound emanating from front wall 13. Appropriately configured openings are provided in sound insulator 23 and in front wall 13 to allow a steering rod 24, foot pedals 17, heating ducts and electrical lines to extend through the same.

Detail X of sound insulator 23 is shown in an expanded view in FIG. 2. In particular, sound insulator 23 is made of a foam layer 25, which is adapted to the shape of front wall 13. A heavyweight film 26 is applied to foam layer 25. A thin, elastic, preferably preformed film 27 is hermetically heat-sealed to heavyweight film 26. Elastic film 27 is adapted to the shape of adjacent wall 28 of instrument panel 15, respectively to the adjacent aggregates. Heavyweight film 26 and elastic film 27 enclose a gastight space, permitting formation of an air cushion 29. A fitting connection 30 for compressed air is incorporated in elastic film 27. In this context, once air cushion 29 is formed (i.e., once elastic film 27 is deployed), its three-dimensional form (hollow body) allows sound insulator 23 to also function without positive pressure (i.e., at zero pressure), particularly when elastic film 27 has been preformed.

To install sound insulator 23, foam layer 25, together with heavyweight film 26 and elastic film 27, is placed in the intermediate free space between front wall 13 and instrument panel 15, air cushion 29 being not yet or only partially formed. The internal pressure in air cushion 29 is subsequently increased, preferably to the point of full deployment, so that foam layer 25 and elastic film 27 rest against the outer contour of front wall 13 and of wall 28, and, respectively, against the aggregates, conforming closely thereto.

When, during operation of the passenger vehicle, structure-borne noise is transmitted from engine 2, fan 3, tires 9 and by the air stream to front wall 13, sound insulator 23 effectively prevents the level of the airborne noise transmitted in passenger compartment 12 from reaching an undesirable value at the ears of the vehicle occupant(s). The mass per unit area of heavyweight film 26 is equal to, preferably, however, substantially greater than that of elastic film 27. Therefore, heavyweight film 26, together with foam layer 25, acts as a spring-mass system. By properly dimensioning the layer thickness of foam layer 25 and of heavyweight film 26, the resonant frequency of the spring-mass system is within a range that is not critical to the damping action. At the openings provided for steering rod 24, foot pedal 17, and cables and hoses, elastic film 27 is configured in such a way that, in response to deployment of air cushion 29, it rests against these components, sealingly surrounding the same.

### LIST OF REFERENCE NUMERALS

1 body

2 engine

3 fan

4-6 sound-insulating element

7 wheel

8 spring

9 tires

10 roadway

11 engine compartment

12 passenger compartment

13 front wall

14 engine-compartment hood

15 instrument panel

16 steering wheel

17 foot pedal

18 seat

19 window

20 sound-absorption mat

21 sound-damping lining

22 carpet

23 sound insulator

24 steering rod

25 foam layer

26 heavyweight film

27 elastic film

28 wall, aggregates

29 air cushion

30 fitting connection

1-5. (canceled)

6. A sound insulator for a passenger compartment of a vehicle, comprising:
an active damping envelope including an elastic material and having an air cushion disposed between a sound-emitting component and an interior of the passenger compartment; and
a sound-absorption layer adapted to a shape of the component and acting as a spring-mass system;
the envelope including a first shell having a heavyweight film sealing the sound-absorption layer on the passenger-compartment side and a second shell made of an elastic film sealingly bonded to the heavyweight film, the air cushion being formed between the first and second shells; and

7. The sound insulator as recited in claim 6 wherein the sound-absorption layer made of a porous, sound-insulating material resting directly against the component and bonded to the heavyweight film.

8. The sound insulator as recited in claim 7 wherein the porous, sound-insulating material is made of foam, nonwoven material or glass wool.

9. The sound insulator as recited in claim 6 wherein the elastic film forming the second shell is adapted to the shape of at least one surrounding component.

10. The sound insulator as recited in claim 6 wherein the mass per unit area of the elastic film forming the second shell is less than or equal to the mass per unit area of the heavyweight film.

11. The sound insulator as recited in claim 6 wherein at least one opening is provided in the sound-emitting component and in the sound-absorption layer, the elastic film forming the second shell surrounding a second component extending through the opening.
